(19) United States
(12) Patent Application Publication
(10) Pub. No.: US 2011/0006695 A1
(43) Pub. Date: Jan. 13, 2011

(54) Device and Method for Generating an Ignition Voltage for a Lamp

(76) Inventor: Herbert Kästle, Traunstein (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/919,442

(22) PCT Filed: Feb. 25, 2008
(86) PCT No.: PCT/EP08/52220

§ 371 Date: Aug. 25, 2010

(51) Int. Cl. H05B 37/02

(52) U.S. Cl. 315/209 R

(57) ABSTRACT

A device for generating an igniting voltage for a lamp, comprising: a first resonant circuit that is connected to the lamp via a switch; and a second resonant circuit connected upstream of said first resonant circuit.

The invention relates to a device and a method for generating a starting voltage for a lamp.

High pressure gas discharge lamps (so called High Intensity Discharge (HID) lamps) for example HE-HCI lamps or MF-HCI lamps, that are operated as a rule with operating frequencies of higher than 20 kHz, are known.

For example, the operation of a high efficiency (HE) lamp, in particular an HE-HCI lamp (HCI: mercury ceramic iodide) or a mercury-free metal halide lamp requires a sinusoidal power frequency operating voltage whose operating frequency is varied in saw-tooth fashion (wobbled or swept) in a range of between 45 kHz to 55 kHz, most in a 100 Hz cycle, depending on the geometry of the lamp burner.

In a so called sweep operation, stabilizing acoustic resonances are excited in the lamp and the plasma arc is thereby additionally stabilized (so called arc straightening).

Alongside the sweep operation, the swept power frequency operating voltage is additionally also amplitude modulated, it being advantageously possible to set the modulation in accordance with the geometry of the lamp burner both in frequency mostly between 23 kHz to 30 kHz, and in modulation depth of between 5% to 30%.

The amplitude modulation serves to excite a specific longitudinal acoustic resonance in the plasma arc that effects an intensified mixing of the gas components in the combustion chamber (color mixing).

Sweep operation and amplitude modulation lead to a more homogeneous luminance along the plasma arc, and to a significant increase in the light yield, an increase in efficiency of, for example, 80 LPW to 150 LPW being enabled.

The operation of an HE-HCI lamp or an MF-HCI lamp requires an AC operating voltage in a frequency range between preferably 20 kHz and 100 kHz.

An output stage of an electronic ballast (EVG) is mostly embodied via a specifically tuned resonant circuit (half bridge inverter or full bridge inverter) for coupling to the lamp.

Such a resonant circuit designed for normal operation of the lamp is not suitable for generating a high igniting voltage (in particular higher than 10 kV).

Since the voltage for igniting the lamp (hot igniting voltage) lies in a range of more than 10 kV in terms of absolute value, from the point of view of insulation technology also such a high voltage should not be generated directly in the electronic ballast.

Furthermore, in the case of general lighting the possibility of a variable wiring arrangement in conjunction with a variable length of line up to a length of, for example, 3 m and the limited suitability of the lines to conduct voltages above 10 kV must be taken into account as additional boundary condition. This likewise contradicts generating higher igniting voltages directly in or at the output of the electronic ballast.

The hot starting voltage is mostly implemented with the aid of a separate ignition unit, this ignition unit being looped in series into the lamp circuit in the immediate vicinity of the lamp.

However, in normal operation such serially looped hot igniting voltage modules have a substantial saturation resistance that causes significant electrical operating losses.

It is the object of the invention to avoid the above-named disadvantages and, in particular, to render it possible to provide a starting voltage for a lamp, this measure enabling low to no loses during normal operation of the lamp (after its switch-on phase).

This object is achieved in accordance with the features of the independent patent claims. Developments of the invention follow from the dependent claims.

In order to achieve the object, a device is specified for generating an igniting voltage for a lamp,
comprising a first resonant circuit that is connected to the lamp via a switch,
a second resonant circuit being connected upstream of the first resonant circuit.

To this extent, it is possible for the first resonant circuit to be used to activate the switch directly, and for the electrical energy present in the resonant circuit to be used to ignite the lamp.

A high igniting voltage can be achieved in an efficient way owing to the series connection of the second and first resonant circuits. It is preferred to provide between the second resonant circuit and the first resonant circuit a forward line via which electrical energy can be transported efficiently in the form of a low voltage, the actual transformation into the high voltage taking place in the first resonant circuit.

One development is to be able to activate the switch with the aid of a resonating voltage in the first resonant circuit.

One development is that the switch comprises at least one of the following components:
a spark gap;
a semiconductor switch;
a starting electrode.

It is also a development that the second resonant circuit supplies the first resonant circuit with electrical energy via a line in order to generate the igniting voltage.

It is also a development that the second resonant circuit is arranged in an electronic ballast.

In this case, the electronic ballast can comprise a half bridge circuit or a full bridge circuit, in particular for operating the second resonant circuit.

Furthermore, one development is that a microcontroller and/or a processor unit is provided that drives the second resonant circuit and/or the first resonant circuit.

In particular, the microcontroller or the processor unit drives the half bridge or the full bridge of the electronic ballast in order thereby to excite the first resonant circuit or the second resonant circuit with electrical pulses or signals in conjunction with a frequency that can be set.

Within the scope of an additional development, it is possible that the microcontroller drives the first resonant circuit and/or the second resonant circuit repeatedly, in particular with varying frequencies.

It is thereby possible to provide a plurality of cycles, in particular with varying frequencies, for the purpose of generating the igniting voltage.

A next development consists in that the first resonant circuit and the switch are arranged in the vicinity of the lamp.

It is preferably possible thereby to supply the igniting voltage directly to the lamp via a short line.

One refinement is that the first resonant circuit is arranged in a hot ignition module.

An alternative embodiment consists in that the first resonant circuit is connected to the switch in series.

A next refinement is that a bypass element is provided in parallel with the series circuit composed of the first resonant circuit and the switch.

The bypass element is preferably set up in such a way that the first resonant circuit consumes as little energy as possible during normal operation of the lamp (after its ignition).

It is also a refinement that the bypass element is a series impedance.

One development consists in that the bypass element comprises a series impedance in the lamp forward line and/or a series impedance in the lamp return line.

An additional refinement is that the series impedance in the lamp forward line and the series impedance in the lamp return line are arranged in a different orientation on a core.

Another refinement is that the lamp is a high pressure gas discharge lamp, in particular an HE-HCI lamp.

The above-named object is also achieved by a method for driving the above-named device by means of a processor device or by means of a hard wired logic circuit.

In particular, the second resonant circuit and/or the first resonant circuit are/is driven with the aid of the processor unit or with the aid of the hard wired logic circuit (for example by means of an ASIC or an FPGA) in such a way that one or more resonant frequencies can be excited.

Exemplary embodiments of the invention are illustrated and explained below with the aid of the drawings, in which:

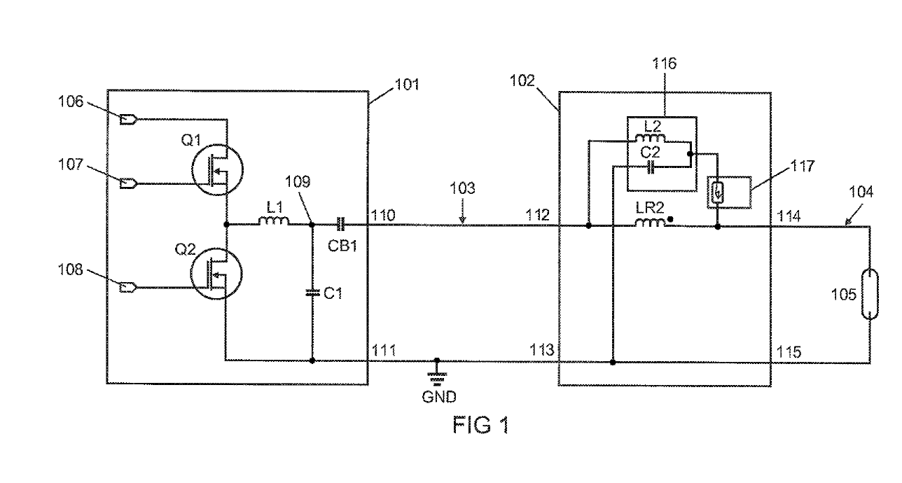

FIG. 1 shows a circuit arrangement for operating a gas discharge lamp via an electronic ballast that is designed as a half bridge, and a hot ignition module that is connected to the electronic ballast via a a lamp line and is preferably provided in the vicinity of the gas discharge lamp;

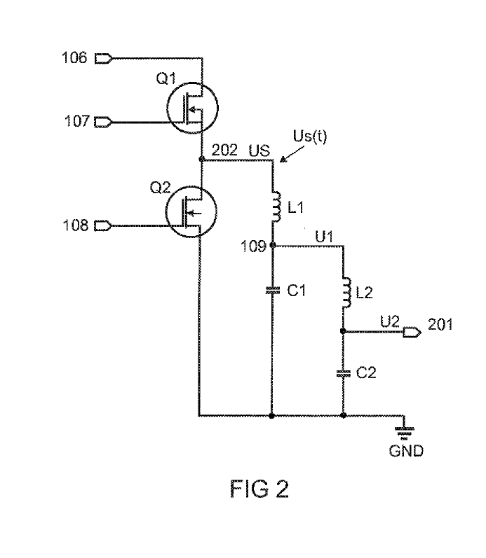

FIG. 2 shows a modeling circuit comprising two resonant circuits that are connected in series;

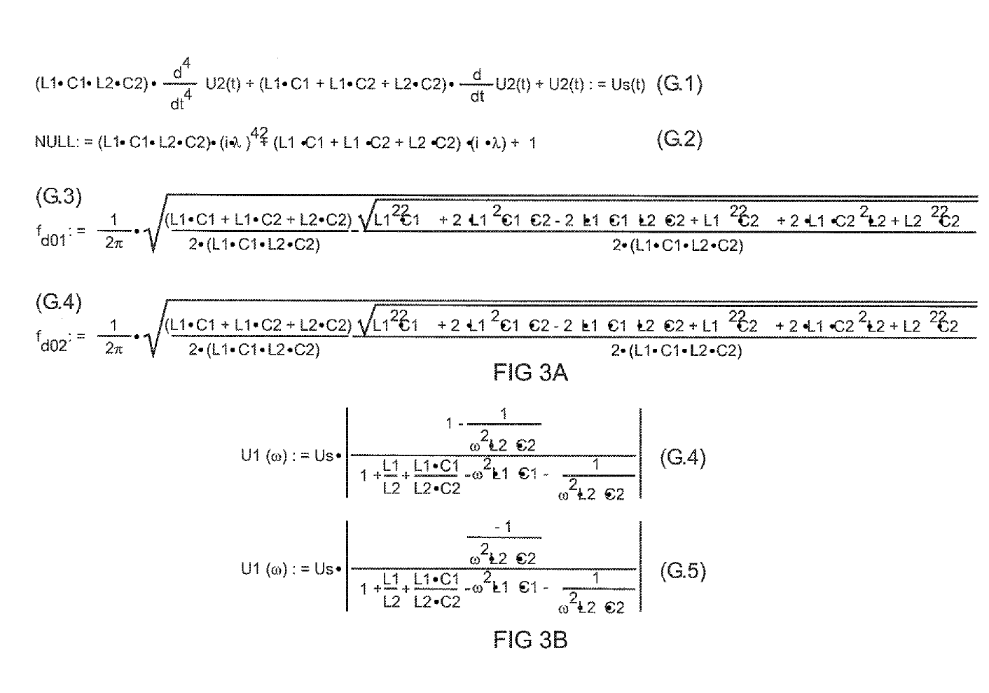

FIG. 3A shows equations that can be used, in particular, to determine the resonance frequencies;

FIG. 3B shows equation that represent the voltage characteristics as a function of the frequency for the coupled resonant circuits in accordance with FIG. 2;

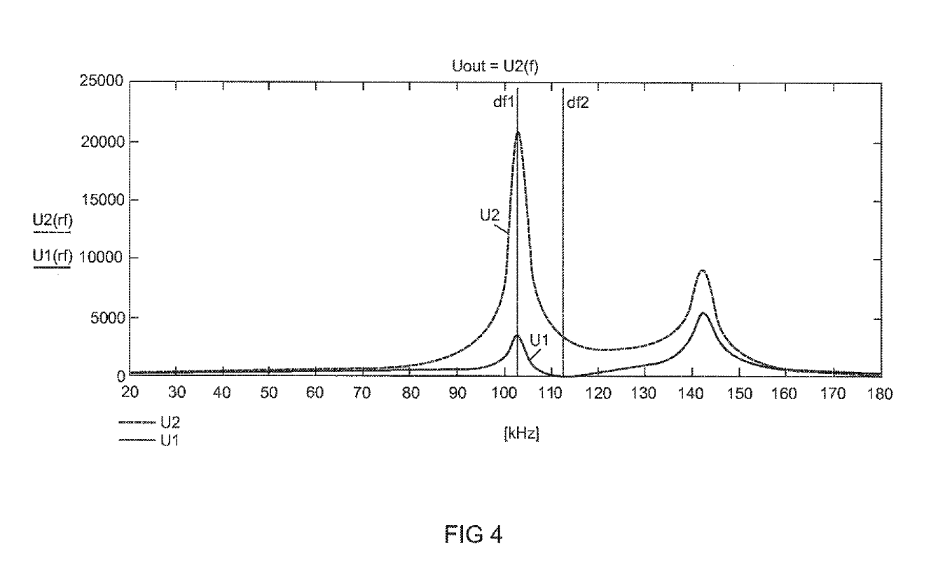

FIG. 4 shows characteristics and position of resonance points as a function of the frequency for the hot ignition module operated via the EVG half bridge;

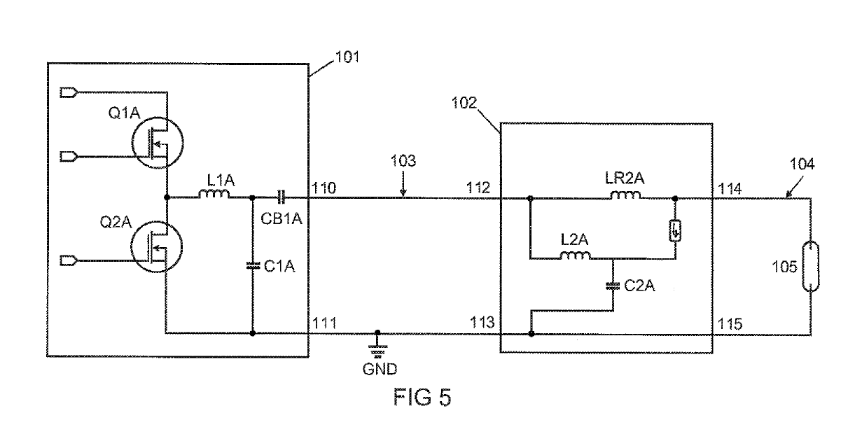

FIG. 5 shows a circuit arrangement in accordance with FIG. 1 with a feedthrough impedance or series inductance in a lamp forward line;

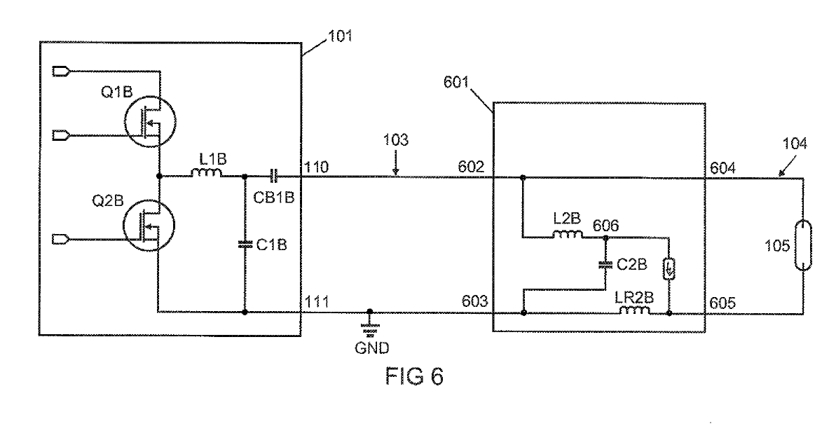

FIG. 6 shows a circuit arrangement in accordance with FIG. 1 with a feedthrough impedance or series inductance in a lamp return line;

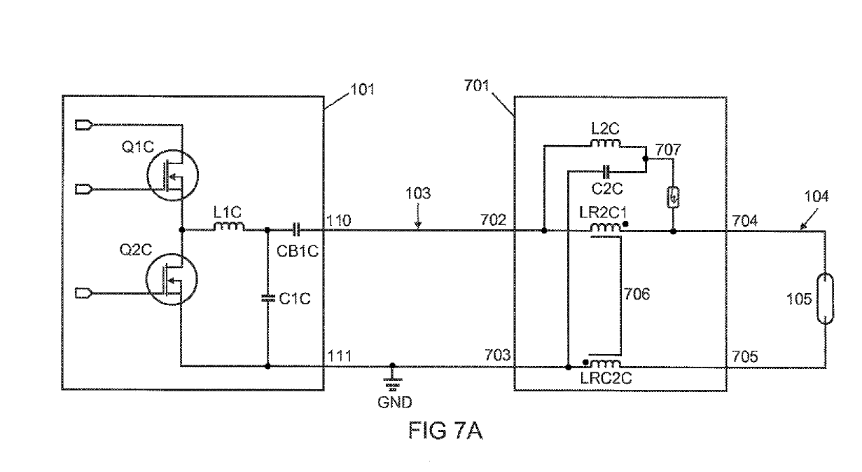

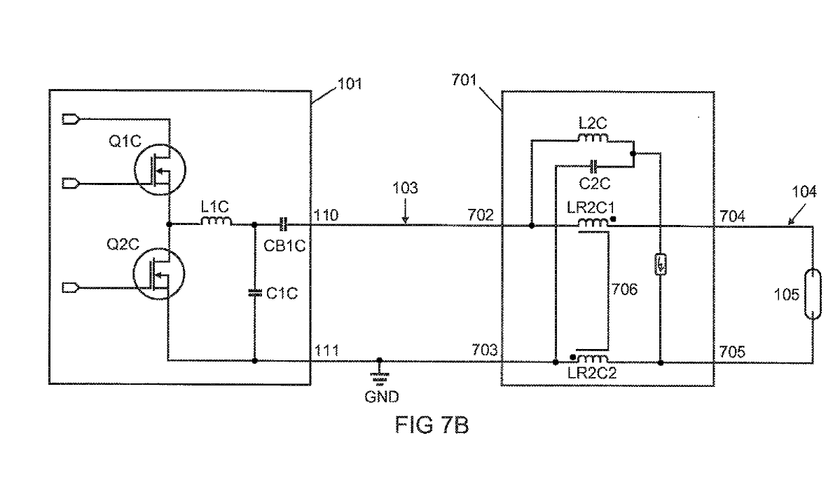

FIG. 7A, FIG. 7B show a circuit arrangement in accordance with FIG. 1 with a feedthrough impedance or series inductance in the lamp forward line as well as with a feedthrough impedance or series inductance in the lamp return line, the two feedthrough impedances being arranged in opposing windings on a common core; and

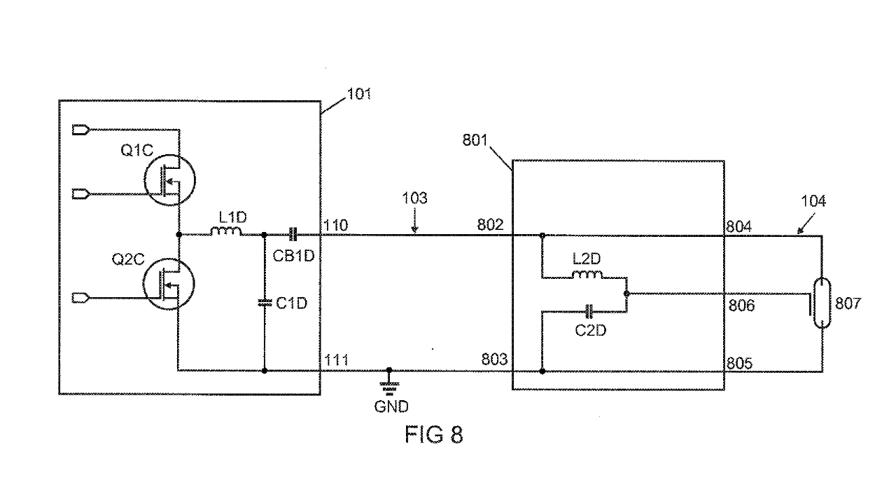

FIG. 8 shows a circuit arrangement in accordance with FIG. 1 without feedthrough impedance, a resonance circuit provided in the hot ignition module generating a starting voltage that is coupled to the lamp directly (preferably capacitively) by means of a starting electrode.

An electronic ballast (EVG) is provided for operating a gas discharge lamp (HID lamp).

The output of the electronic ballast preferably has a half bridge inverter or a full bridge inverter with the aid of which a nominal operation of the lamp is enabled at frequencies of between 20 kHz and 100 kHz.

Different lamp line lengths of, for example, up to 3 m between electronic ballast and lamp are possible in the field of application of general lighting, in particular. In this case, it is disadvantageous for reasons of voltage endurance, in particular, to conduct a starting voltage of more than 10 kV over this entire lamp line length.

In particular, a hot ignition module can advantageously be placed in the immediate vicinity of the lamp (preferably at a spacing of approximately 30 cm at most) in order to start the lamp. This hot ignition module generates the required starting voltage pulses >10 kV, but it is preferred for these starting voltage pulses to be released only toward the lamp on the remaining short lamp piece of line, and not in retroactive fashion over the longer pieces of line in the direction of the electronic ballast.

During normal operation of the lamp, that is to say its ignition or switch-on phase, the hot ignition module preferably has a low feedthrough inductance (preferably smaller than a few 100 μH), in order to minimize the operating losses.

It is, in particular, proposed that the hot ignition module be looped into the lamp line in the immediate vicinity of the lamp and constitute a sufficiently low feedthrough impedance for the high frequency operating mode of an HE-HCI lamp or an MF-HCI lamp.

The hot ignition module preferably has means for generating voltage pulses that are preferably at a level of approximately 20 kV for the purpose of generating the starting pulses.

The hot ignition module itself can be operated directly via the lamp forward lines via the electronic ballast, and therefore itself requires no active control electronics or any additional external power supply for generating the voltage pulses.

In order to achieve a low feedthrough impedance of the hot ignition module during normal operation of the lamp, the hot ignition module is advantageously decoupled from the electronic ballast and from the lamp with the aid of a low series inductance (for example of the order of magnitude of 200 μH). The series inductance is connected between the input and the output of the hot ignition module.

A high voltage pulse (HV pulse) that is fed toward the lamp into the shorter piece of line downstream of the series inductance can now be generated in the hot ignition module in parallel with the series inductance mentioned.

The series inductance preferably has an adequate high voltage endurance.

The approach presented here advantageously enables the generation of the voltage pulses for starting the lamp without the use of further active electronics in the hot ignition module. This is preferably achieved by providing in the hot ignition module a suitably designed high quality LC resonant circuit that can be operated and excited by the electronic ballast directly via the lamp forward lines.

The LC resonant circuit in the hot ignition module is preferably initially operated in an isolated and free wheeling fashion such that the resonance can oscillate at voltage values of up to 20 kV largely without the influence of external damping influences with as little damping as possible and in conjunction with high quality.

The oscillating LC resonant circuit is coupled in the direction of the lamp to the piece of line via a switch when a specific voltage level or voltage range, for example 15 kV to 20 kV is reached. The switch can be implemented in different ways in this case. For example, the switch can comprise a spark gap with a prescribed breakthrough voltage, a semiconductor switch or a starting electrode.

As soon as the LC resonant circuit of the hot ignition module has reached a value of between 15 kV and 20 kV, the connected spark gap switches through at its defined breakthrough voltage and couples the existing voltage level directly into the shorter connecting line to the lamp.

This starting voltage strikes a high resistance lamp and generates a starting breakdown in it.

The electronic ballast connected to the hot ignition module is itself always connected to the lamp such that it can function via the internal low inductance series inductance and, after detection of the starting breakdown, can take up its normal lamp operation directly, in this case the lamp startup operation.

The arrangement described is illustrated in FIG. 1.

FIG. 1 comprises an EVG half bridge 101 that is connected to a hot ignition module 102 via a lamp line 103. A lamp 105 is connected to the hot ignition module 102 via a lamp line 104.

The lamp line 103 is preferably designed to be shorter than 3 meters, and the lamp line 104 is preferably designed to be shorter than 30 centimeters.

The EVG half bridge 101 comprises three inputs 106, 107 and 108, two outputs 110 and 111, two semiconductor switches, in particular n-channel MOSFETS, Q1 and Q2, a coil L1 and two capacitors C1 and CB1.

The input 106 supplies the EVG half bridge 101 with a voltage, while the input 107 is connected to the gate terminal of the MOSFET Q1 and the input 108 is connected to the gate terminal of the MOSFET Q2. The source terminal of the MOSFET Q1 is connected to the drain terminal of the MOFSET Q2 and, via the coil L1, to a node 109. The capacitor C1 is connected on the one hand to the node 109, and on the other hand to the source terminal of the MOSFET Q2 as well as to the output 111. The capacitor CB1 is connected to the node 109 on the one hand and to the output 110 on the other hand. The drain terminal of the MOSFET Q1 is connected to the input 106.

The hot ignition module 102 comprises inputs 112 and 113 as well as outputs 114 and 115. The hot ignition module 102 further comprises an LC resonant circuit 116, a switch 117 and a coil LR2 (series inductance).

The LC resonant circuit 116 comprises a coil L2 and a capacitor C2. The switch 117 is preferably designed as a spark gap (for example 17 kV).

The coil L2 is connected to the input 112, on the one hand, and to a terminal of the capacitor C2 as well as to a terminal of the switch 117, on the other hand. The other terminal of the capacitor C2 is connected to the input 113 which, in turn, is connected to the output 115. The other terminal of the switch 117 is connected to the output 114 and, via the coil LR2, to the input 112.

The lamp 105 is connected to the outputs 114 and 115 of the hot ignition module 102. The lamp 105 is preferably designed as a high pressure gas discharge lamp.

In order to start the lamp 105, the EVG half bridge 101 is used to excite the LC resonant circuit 116 until, via the switch 117, the latter transmits a voltage >15 kV to the lamp 105 via the output 114 and preferably starts the lamp 105.

After being started by the hot ignition module 102, the lamp 105 can be operated via the series inductance LR2 with the aid of the EVG half bridge 101 (normal operation of the lamp 105).

During normal operation, the lamp 105 is preferably operated in a frequency range (for example smaller than 100 kHz) in which the LC resonant circuit 116 is virtually completely passive. Consequently, no excess starting voltages occur, in particular.

The inputs 107 and 108 of the EVG half bridge are suitably driven, particularly via a microcontroller or a processor, to excite the resonant circuits with specific frequencies. It is possible for the variation in frequency itself to be modulated, and/or for specific frequency cycles to be generated in order to cover the resonant frequency/frequencies of the resonant circuits. It is also possible to carry out a plurality of starting operations one after another, in order to ensure that the lamp starts. It is also possible to use the control device (processor, microcontroller or similar) after a prescribed number of starting operations to check whether the lamp is burning. If appropriate, a lamp that is not burning can be detected as a fault and the system can be switched off.

The capacitor CB1 (“blocking capacitor”) of the EVG half bridge 101 is preferably of large dimension and serves to block a DC component from the half bridge. This capacitor CB1 scarcely influences the position of the resonance points. Alternatively, the capacitor CB1 can also be provided at another point, for example in the lamp return line.

Given a blocking capacitor of low capacitance, there is no quality change in the behavior of the circuit and/or the system. The only thing is that the position of the resonance points is slightly displaced. This can be met by an appropriate consideration of the capacitance of the blocking capacitor when determining the resonance.

During nominal lamp operation, the operating voltages that occur are far below 5 kV in accordance with the lamp burning voltages that are current, and the connected spark gap of the switch 117 decouples the output of the LC resonant circuit 116 completely from the output 114 of the hot ignition module 102.

The LC resonant circuit 116 of the hot ignition module 102 is preferably designed in such a way that it has no resonance points in nominal lamp operation (in particular, for an operating frequency of lower than 100 kHz). To this end, it is preferred to prescribe a natural resonant frequency of the LC resonant circuit 116 that is higher than 100 kHz. Values of up to 30 mH can thereby be provided for the inductance L2.

In the example, the natural resonant frequency of the LC resonant circuit 116 in the hot ignition module 102 is yielded from

$${f}_{0 \; 2} = \frac{1}{2 \cdot π} \cdot \sqrt{\frac{1}{L 2 \cdot C 2}} ..$$

For
L2=20 mH and
C2=100 pF

the natural resonance frequency of the LC resonant circuit 116 is accordingly
f₀₂=112.5 kHz.

At this frequency f₀₂, the outer LC resonant circuit 116 in the hot ignition module 102 has a lower impedance. Operation at this frequency is preferably to be avoided, since here the output voltage of the resonant circuit of the EVG half bridge based on the coil L1 and the capacitor C1 will be held to zero and loaded in the fashion of a short circuit.

In order to determine the active frequencies for the excitation of the LC resonant circuit 116 in the hot ignition module 102, the half bridge resonant circuit in the EVG half bridge 101 is also taken into account as source resonance.

An equivalent circuit diagram of two series connected resonant circuits in accordance with FIG. 2 is particularly suitable for determining the resonance points.

The design of FIG. 2 corresponds largely to FIG. 1. Only the capacitor CB1, the switch 117 as well as the series inductance LR2 and the lamp 105 are omitted. This results in the two resonant circuits L1C1 and L2C2, the center tap between L2 and C2 being denoted as a node 201, and a voltage U2 being present at this node (the switch 117 is connected to this node in FIG. 1).

The resonant circuit L1C1 represents a source resonance in the EVG half bridge, and the resonant circuit L2C2 represents a hot ignition resonance in the hot ignition module.

Equations (G.1) to (G.6) are shown in FIG. 3A and FIG. 3B).

The double resonant circuit resulting from FIG. 2 can be described by the differential equation (G.1). The associated characteristic polynomial is of degree 4 and is specified in equation (G.2). The four associated pairwise complex conjugate zero points are yielded by the two resonant frequencies f_{d01} and f_{d02} in accordance with the equations (G.3) and (G.4). The resonant frequencies are given as
f_{d01}=102.7 kHz and
f_{d02}=142.4 kHz

for the above example.

At the resonance frequencies f_{d01} and f_{d02}, the output of the double resonant circuit, that is to say the output of the LC resonant circuit (116 in accordance with FIG. 1) in the hot ignition module resonates.

It is advantageous here to use the resonance frequency with the lower frequency in order to achieve lower losses in the capacitive and inductive components, and thus a correspondingly high quality.

Should the efficiency of the upper resonance point be higher, this can also be used to generate the starting voltage.

The frequency responses for the voltages of the two coupled resonant circuits can be determined with the aid of equations (G.5) and (G.6) by means of the solved differential equation and a subsequent Fourier transformation into the frequency range.

An angular frequency of w=2πf and a source voltage Us (the latter being present at a node 202 between the MOSFETs Q1 and Q2) yield a voltage characteristic U1(f) at the output of the EVG half bridge (that is to say at the node 109), and a voltage characteristic U2(f) at the output of the ignition resonance (that is to say at the terminal 201) in the hot ignition module. These two voltage characteristics are illustrated in FIG. 4, the influences of any possible damping factors such as, for example, core losses or eddy current losses that influence the level of the excess resonances not also being taken into account completely.

The voltage characteristic U1(f) corresponds to the voltage characteristic against the frequency for the output of the inner resonant circuit directly at the output of the EVG half bridge, and the voltage characteristic U2(f) corresponds to the voltage characteristic against the frequency for the output of the outer resonant circuit directly at the input of the 15 kV spark gap.

The lamp is preferably operated in a frequency range of from 20 kHz to 90 kHz (see above statements in connection with FIG. 1). The resonance points of the hot ignition module behave in a largely passive fashion in this frequency range.

The frequency f_{d01}=102.7 kHz is the first resonant frequency of the double resonant circuit at which a lamp can be excited at the output of the ignition module. The frequency f₀₂=112.5 kHz corresponds to the natural resonant frequency of the LC resonant circuit 116 in accordance with FIG. 1, at which the inner resonant circuit (L1C1 in FIG. 1) is loaded in the fashion of a short circuit. At the frequency f_{d02}=142.4 kHz, the double resonant circuit has its second resonant frequency with the aid of which the lamp can likewise be excited at the output of the ignition module.

Developments and alternative embodiments are shown in the following circuit examples.

FIG. 5 shows a circuit arrangement comprising the EVG half bridge 101 as well as the hot ignition module 102 in accordance with FIG. 1.

The series inductance LR2 provided in the hot ignition module 102 is arranged in this case in the lamp forward line, and the high voltage generated in the hot ignition module 102 is coupled into the lamp forward line.

FIG. 6 shows a circuit arrangement comprising the EVG half bridge 101 that is connected via the lamp line 103 to a hot ignition module 601 (comprising inputs 602 and 603 as well as outputs 604 and 605), in particular to the inputs 602 and 603 of the hot ignition module 601. The lamp 105 is connected via the lamp line 104 to the outputs 604 and 605 of the hot ignition module 601.

The input 602 is connected to the output 604 in the hot ignition module 601. Furthermore, the input 602 is connected to a node 606 via a coil L2B. A capacitor C2B is provided between the node 606 and the input 603, and a switch, in particular a spark gap (15 kV), is arranged between the node 606 and the output 605. The input 603 is connected to the output 605 via a coil LR2B (series inductance).

The series impedance LR2B is located in FIG. 6 in the lamp return line, and the high voltage generated in the hot ignition module 601 is coupled into the lamp return line (at the output 605 of the hot ignition module 601).

FIG. 7A shows an alternative circuit arrangement comprising the EVG half bridge 101 in accordance with FIG. 1, and a hot ignition module 701 (with inputs 702, 703 and outputs 704, 705).

The EVG half bridge 101 is connected to the inputs 702 and 703 of the hot ignition module 701 via the lamp line 103. The lamp 105 is connected to the outputs 704 and 705 of the hot ignition module 701 via the lamp line 104.

The input 702 of the hot ignition module 701 is connected to a node 707 via a coil L2C. A capacitor C2C is situated between the input 703 and the node 707. A spark gap (15 kV) is connected to the node 707, on the one hand, and to the output 704, on the other hand. An inductance LR2C1 is provided between the input 702 and the output 704, and an inductance LR2C2 is provided between the input 703 and the output 705, the inductances LR2C1 and LR2C2 being arranged in a differential direction of arrangement on the same core, the effective total series impedance thereby being simplified in accordance with

L_{ges}=2·(LR2C1+LR2C2)=4·LR2C.

To this extent, in FIG. 7 the continuous series impedance is arranged symmetrically both in the lamp forward line and in the lamp return line.

An advantage of this circuit arrangement consists in that the starting voltage, which is injected or coupled into the lamp forward line via the spark gap becomes active at twice the level because of the transformation effect on the lamp.

FIG. 7B shows an alternative circuit arrangement in accordance with FIG. 7A in the case of which the starting voltage is coupled into the lamp return line via the spark gap and becomes active at twice the level as a consequence of the transformation effect on the lamp.

FIG. 8 shows an alternative circuit arrangement comprising the EVG half bridge 101 in accordance with FIG. 1 and a hot ignition module 801 (with inputs 802, 803 and outputs 804, 805 and 806).

The EVG half bridge 101 is connected to the inputs 802 and 803 of the hot ignition module 801 via the lamp line 103. A lamp 807 is connected to the outputs 804 and 805 of the hot ignition module 801 via the lamp line 104. Furthermore, the lamp 807 has a starting electrode that is fed via the output 806 of the hot ignition module 801.

In the hot ignition module 801, the input 802 is connected to the output 804, and the input 803 is connected to the output 805. Between the input 802 and the output 806 there is provided a coil L2D, and between the input 803 and the output 806 there is arranged a capacitor C2D.

It is possible for a pulsed or a high-frequency high voltage to be coupled capacitively into the lamp with the aid of the starting electrode provided by the output 806 of the hot ignition module 801.

In this case, a separate series impedance can be omitted in the lamp forward line or lamp return line.

The above statements can be transferred correspondingly to an electronic ballast with a full bridge.

1. A device for generating an igniting voltage for a lamp, comprising:
a first resonant circuit that is connected to the lamp via a switch; and
a second resonant circuit connected upstream of said first resonant circuit.

2. The device as claimed in claim 1, wherein the switch can be activated with the aid of a resonating voltage in the first resonant circuit.

3. The device as claimed in claim 1, wherein the switch comprises at least one of the following components:
a spark gap;
a semiconductor switch; and
a starting electrode.

4. The device as claimed in claim 1, wherein the second resonant circuit supplies the first resonant circuit with electrical energy via a line in order to generate the igniting voltage.

5. The device as claimed in claim 1, wherein the second resonant circuit is arranged in an electronic ballast.

6. The device as claimed in claim 1, wherein a microcontroller and/or a processor unit is provided that drives the second resonant circuit and/or the first resonant circuit.

7. The device as claimed in claim 6, wherein the microcontroller drives the first resonant circuit and/or the second resonant circuit repeatedly.

8. The device as claimed in claim 1, wherein the first resonant circuit and the switch are arranged in the vicinity of the lamp.

9. The device as claimed in claim 1, wherein the first resonant circuit is arranged in a hot ignition module.

10. The device as claimed in claim 1, wherein the first resonant circuit is connected to the switch in series.

11. The device as claimed in claim 10, wherein a bypass element is provided in parallel with the series circuit composed of the first resonant circuit and the switch.

12. The device as claimed in claim 11, wherein the bypass element is a series impedance.

13. The device as claimed in claim 11, wherein the bypass element comprises a series impedance in the lamp forward line and/or a series impedance in the lamp return line.

14. The device as claimed in claim 13, wherein the series impedance in the lamp forward line and the series impedance in the lamp return line are arranged in a different orientation on a core.

15. The device as claimed in claim 1, wherein the lamp is a high pressure gas discharge lamp.

16. A method for driving the device in accordance with claim 1 by a processor device or by a hard wired logic circuit.

17. The device as claimed in claim 6, wherein the microcontroller drives the first resonant circuit and/or the second resonant circuit repeatedly with varying frequencies.

18. The device as claimed in claim 15, wherein the lamp is an HE-HCI lamp.
